(19) United States
(12) Patent Application Publication
(10) Pub. No.: US 2026/0202838 A1
(43) Pub. Date: Jul. 16, 2026

(54) RECORDING MEDIUM, CLIENT DEVICE, NETWORK SYSTEM, AND DISPLAY CONTROL METHOD

(71) Applicant: Mitsubishi Electric Corporation, Tokyo (JP)

(72) Inventor: Yukihiro MAEZAWA, Tokyo (JP)

(73) Assignee: Mitsubishi Electric Corporation, Tokyo (JP)

(21) Appl. No.: 19/137,662

(22) PCT Filed: Feb. 17, 2023
(86) PCT No.: PCT/JP2023/005816

§ 371 Date: Jun. 11, 2025

(51) Int. Cl. G05B 23/02

(52) U.S. Cl. CPC G05B 23/0272

(57) ABSTRACT

A program causes a support terminal connectable through a network to a PLC having a function of a server unit distributing information, to function as: a client unit to receive from the server unit information indicating an operating state of the PLC; a display controller to cause a display to display an image indicating the operating state using an icon corresponding to the PLC; a UI to accept an operation on the icon; and a receiver to receive from the PLC, when the operation is accepted by the UI, an execution program executed by the PLC and a log of execution data used upon execution of the execution program. The display controller causes the display to display the execution program and the log that are received.

### TECHNICAL FIELD

The present disclosure relates to a display program, a client device, a network system, and a display control method.

### BACKGROUND ART

At factory automation (FA) sites, systems in which FA devices provided by various manufacturers are connected through networks are established. In such networks, common communication protocols that can be used independent of FA devices or the manufacturers thereof are becoming more widespread. As an example of this kind of communication protocol, open platform communications unified architecture (OPC UA) has been known (see, for example, Patent Literature 1).

Patent Literature 1 discloses how a trigger bit that is turned ON in a programmable logic controller (PLC) upon completion of a process on a production line is detected by a process control system connected to the PLC via the OPC UA, and how data is read from the PLC. The process control system records data in a database and retrieves the data from the database.

### CITATION LIST

### Patent Literature

Patent Literature 1: Unexamined Japanese Patent Application Publication No. 2009-245435

### SUMMARY OF INVENTION

### Technical Problem

As typified by preventive maintenance and corrective maintenance, users sometimes verify operation histories of the PLCs. When the users check data acquired from the PLC according to the technique described in Patent Literature 1, the users are required to be experienced in handling databases to read the data from the databases.

Moreover, the process control system described in Patent Literature 1 can acquire specific data from the data held by the PLC to record the acquired specific data in the database, but the process control system does not always record the data required by the user for verification work in the database. Therefore, the users must separately use tools to access the PLC and utilize a diagnostic function or a monitoring function for the PLC, which increases the workload for verifying the operation histories of the PLCs.

Under such circumstances, an objective of the present disclosure is to reduce the workload for verifying the operation histories of the PLCs.

### Solution to Problem

To achieve the above objective, a display program according to an aspect of the present disclosures is a display program for causing a computer connectable through a network to a programmable controller having a function of a server encrypting and distributing information that is in accordance with a predetermined information model, to function as: client means for receiving from the server the information indicating an operating state of the programmable controller; display controlling means for causing display means to display an image indicating the operating state using an icon corresponding to the programmable controller; user interface means for accepting an operation on the icon; and reception means for receiving from the programmable controller, when the operation is accepted by the user interface means, an execution program executed by the programmable controller and a log of execution data used upon execution of the execution program, wherein the display controlling means causes the display means to display the execution program and the log that are received by the reception means.

### Advantageous Effects of Invention

According to the present disclosure, the user interface means accepts the operation on the icon, the reception means receives the execution program and the log of the execution data from the programmable controller, and the display controlling means causes the display means to display the execution program and the log. As such, users are not necessarily experienced in handling databases, and the users can visually check the execution program and the log of the execution data. This reduces the workload for verifying the operation histories of the PLCs.

### BRIEF DESCRIPTION OF DRAWINGS

FIG. 1 is a diagram illustrating a configuration of a network system according to an embodiment;

FIG. 2 is a diagram illustrating a hardware configuration of an FA device according to the embodiment;

FIG. 3 is a functional block diagram of a support terminal and a PLC according to the embodiment;

FIG. 4 is a table illustrating a first example of information distributed by a server device according to the embodiment;

FIG. 5 is a table illustrating a second example of information distributed by the server device according to the embodiment;

FIG. 6 is a table illustrating a third example of information distributed by the server device according to the embodiment;

FIG. 7 is a diagram for describing an execution program and a log of execution data according to the embodiment;

FIG. 8 is diagram illustrating an example of a configuration diagram of the network system to be displayed by a user interface (UI) according to the embodiment;

FIG. 9 is a diagram illustrating a first example of an operation performed on the UI according to the embodiment;

FIG. 10 is a diagram illustrating an example of details of the server device to be displayed by the UI according to the embodiment;

FIG. 11 is a diagram illustrating a second example of an operation performed on the UI according to the embodiment;

FIG. 12 is a diagram illustrating an example of an execution program and a log to be displayed by the UI according to the embodiment;

FIG. 13 is a diagram illustrating a third example of an operation performed on the UI according to the embodiment;

FIG. 14 is a diagram illustrating a first example of a file according to the embodiment;

FIG. 15 is a diagram illustrating a second example of a file according to the embodiment;

FIG. 16 is a flowchart illustrating display control processing according to the embodiment; and

FIG. 17 is a diagram illustrating a configuration of a support terminal according to a modified example.

### DESCRIPTION OF EMBODIMENTS

A network system according to an embodiment of the present disclosure is described in detail below with reference to the drawings.

### Embodiments

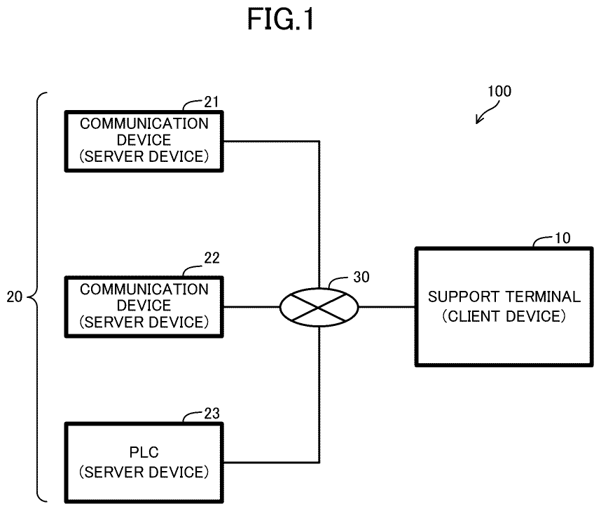

As illustrated in FIG. 1, a network system 100 according to the present embodiment is a system for supporting a user who verifies an operation history of a programmable logic controller (PLC) 23 using a support terminal 10. The network system 100 is constructed as part of a control system for controlling equipment at a factory through a network 30. The control system operates, for example, a production line, a machining process line, an inspection line, and other processes.

The network system 100 includes communication devices 21 and 22, a PLC 23, and a support terminal 10. The communication devices 21 and 22 correspond to a control device to control equipment or a control target device that is a control target. The PLC 23 corresponds to the control device. The support terminal 10 is connected to the communication devices 21 and 22, and the PLC 23 via the network 30. The network 30 is an industrial network such as a field network.

The control system for controlling equipment may include non-illustrated equipment and devices. For example, the communication device 21 that corresponds to the control target device may be controlled by a non-illustrated control device, or the communication device 22 that corresponds to the control device and the PLC 23 may control non-illustrated equipment. The network system 100 may be a system configured by extracting a server to provide information via the network 30 and a client who acquires the information from a control system.

The communication devices 21 and 22, and the PLC 23 have functions of servers. Each of the communication devices 21 and 22 and the PLC 23 may hereafter be referred to as a server device 20 without distinction. The support terminal 10 corresponds to a client device having a function of a client to acquire information from the server device 20. The support terminal 10 corresponds to a user interface terminal. The user interface terminal provides the user with the information acquired from the server device 20 and presents to the user the information relating to the operation history of the PLC 23 to support the verification work of the operation history by the user. The support terminal 10 may be a personal computer (PC) such as an industrial PC, a tablet terminal, or a smart phone, or may be a dedicated user interface device in an FA system, also called a programmable display.

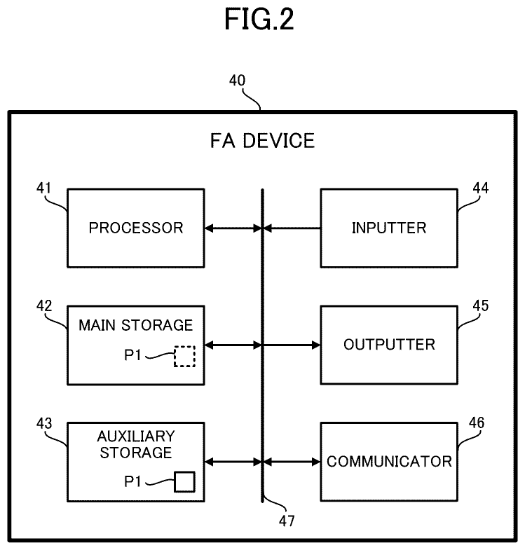

The server device 20 and the support terminal 10 each include hardware components to function as a computer. More specifically, as illustrated in FIG. 2, an FA device 40 corresponding to each of the server devices 20 and the support terminal 10 includes a processor 41, a main storage 42, an auxiliary storage 43, an inputter 44, an outputter 45, and a communicator 46. The main storage 42, the auxiliary storage 43, the inputter 44, the outputter 45, and the communicator 46 are connected to the processor 41 with an internal bus 47.

The processor 41 includes a central processing unit (CPU) or a micro processing unit (MPU) as a processing circuit. The processor 41 executes a program P1 stored in the auxiliary storage 43 to implement various functions and perform processing described later. The program P1 of the support terminal 10 corresponds to an engineering tool, and corresponds to an example of a display program to cause the support terminal 10 to function as described later.

The main storage 42 includes a random-access memory (RAM). The program P1 is loaded into the main storage 42 from the auxiliary storage 43. The main storage 42 is used as a work area for the processor 41.

The auxiliary storage 43 includes a nonvolatile memory such as an electrically erasable programmable read-only memory (EEPROM) or a hard disk drive (HDD). The auxiliary storage 43 stores, in addition to the program P1, various sets of data used for processing performed by the processor 41. The auxiliary storage 43 provides data to be used by the processor 41 to the processor 41 in accordance with instructions of the processor 41. The auxiliary storage 43 stores data provided by the processor 41. The auxiliary storage 43 of the PLC 23 stores, in addition to the program P1, an execution program to perform control processing. The execution program is, for example, a ladder program or a program written in a high-level language such as the C language. The execution program is performed by the processor 41 of the PLC 23.

The inputter 44 includes an input device such as a hardware switch, an input key, a keyboard, and a pointing device. The inputter 44 acquires information input by the user of the FA device 40 and sends a notification of the acquired information to the processor 41.

The outputter 45 includes an output device such as a light-emitting diode (LED), a liquid crystal display (LCD), and a speaker. The outputter 45 presents various sets of information to the user in accordance with instructions of the processor 41. The outputter 45 of the support terminal 10 includes a display device such as the LCD, and functions as part of a graphical user interface (GUI). Furthermore, a display device corresponding to the outputter 45 and a pointing device corresponding to the inputter 44 in the support terminal 10 may constitute a touchscreen.

The communicator 46 includes a communication interface circuit to communicate with an external device. The communicator 46 receives a signal from the outside, and outputs data indicated by the signal to the processor 41. The communicator 46 also transmits a signal indicating data output from the processor 41 to the external device.

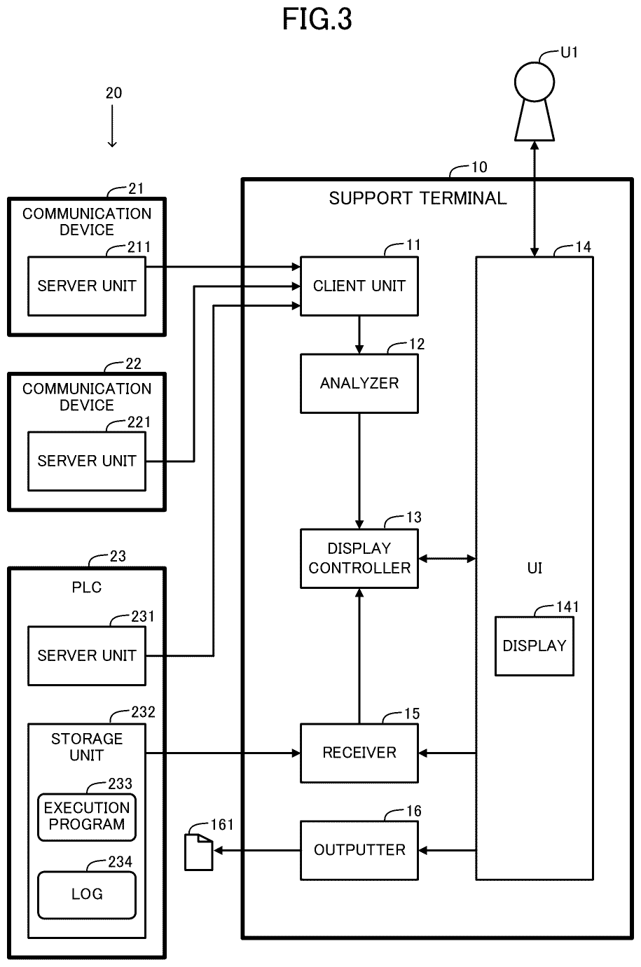

The hardware components described above cooperate with one another to allow the server devices 20 and the support terminal 10 to implement various functions. More specifically, as illustrated in FIG. 3, the communication device 21 includes a server unit 211 to distribute information using a predetermined communication protocol. Similarly, the communication device 22 includes a server unit 221, and the PLC 23 includes a server unit 231. The server units 211, 221, and 231 are each mainly achieved by the processor 41 and the communicator 46 operating in cooperation with each other. The server units 211, 221, and 231 each distribute information in a format in accordance with the OPC UA protocol as the communication protocol described above. The PLC 23 corresponds to an example of a programmable controller having a function of a server to encrypt information that is in accordance with the predetermined information model and distribute the information.

The OPC UA is a communication protocol used for sending a notification of information of the FA devices to the outside via the industrial network. The OPC UA is a standard protocol that is often adopted for the FA devices since the OPC UA can encrypt the information that is in accordance with the predetermined information model independent of the operating system (OS) on the server or client side, and distribute the information. Here, encryption of information in the OPC UA is performed by a public-key cryptography method on the basis of application authentication using certificates.

The information model in the OPC UA is a model that expresses a structure of information recursively by allowing nodes to refer the other nodes of types such as Object, Variable that represents state values of the Object, and Method that represents behavior of the Object. For example, an information model that includes a Variable node indicating a presence or absence of abnormality in the server device 20 is predefined and is shared among the server units 211, 221, and 231, and a client unit 11 described later. Then, by distribution of the state value of the Variable node from the server device 20 in response to a request from the client unit 11, a user U1 of the support terminal 10 including the client unit 11 can determine an operating state of the server device 20.

Additionally, upon the server device 20 providing information via the OPC UA, the server device 20 appends a status code indicating whether there is any issue with the information, and provides the information with the status code to the client unit 11. Then, the user U1 of the support terminal 10 can refer to the status code to determine whether any abnormality has occurred in the server devices 20.

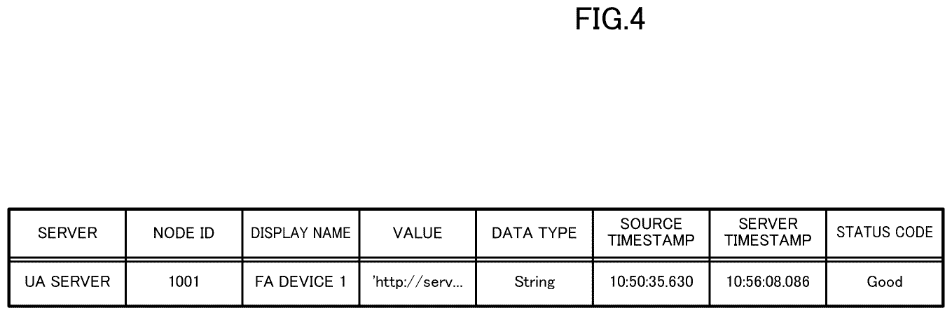

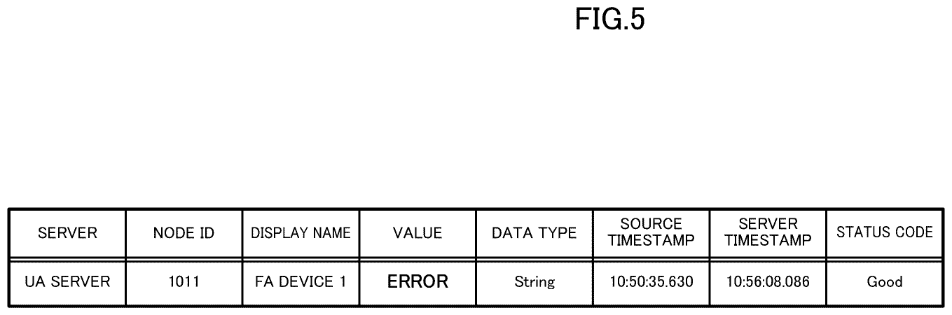

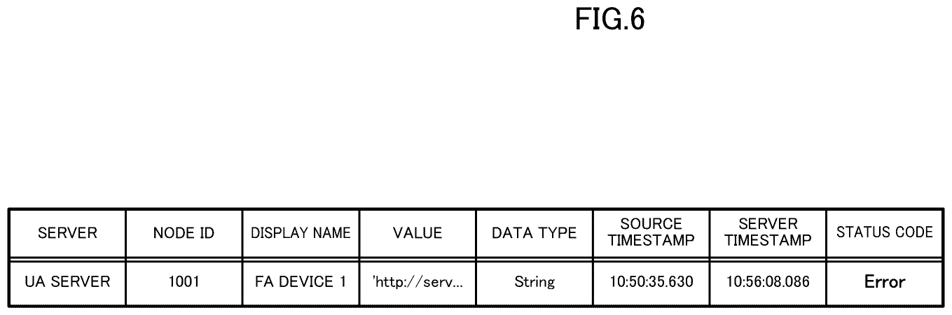

FIGS. 4-6 each illustrate an example of information provided from the server device 20. As illustrated in FIG. 4, the information includes a server providing information, a node identifier (ID) for identifying a node in a predefined information model, a display name of the node, a value of the node, a data type of the value, a source timestamp, a server timestamp assigned by the server device 20, and a status code that are associated with one another. In the example of FIG. 5, the value of the node is “Error”, indicating that an abnormality occurred in the server device 20. Additionally, in the example of FIG. 6, the status code is “Error”, indicating that an abnormality occurred in the server device 20.

Here, the abnormality indicated as being occurred by the information provided from the server device 20 is an event that is detected at the server device 20 and satisfies a predetermined condition. The abnormality typically represents an operating state of the server device 20 that deviates from a range expected to be a normal operating state by an administrator of the server device 20. Examples of such abnormalities include an abnormality in memory, an abnormality in temperature, and an abnormality in communication.

With reference again to FIG. 3, the PLC 23 includes a storage unit 232 storing the execution program 233 and a log 234. The storage unit 232 is mainly achieved by at least one of the main storage 42 or the auxiliary storage 43 of the PLC 23, the processor 41, and the communicator 46 operating in cooperation with one another. The storage unit 232 stores the execution program 233 executed or being executed by the PLC 23, and the log 234 of the execution data used upon the execution of the execution program 233. The logging of the execution data is achieved, for example, by periodically overwriting the value of the execution data to a ring buffer. Then, the storage unit 232 transmits the execution program 233 and the log 234 to the support terminal 10 in response to a request from the support terminal 10.

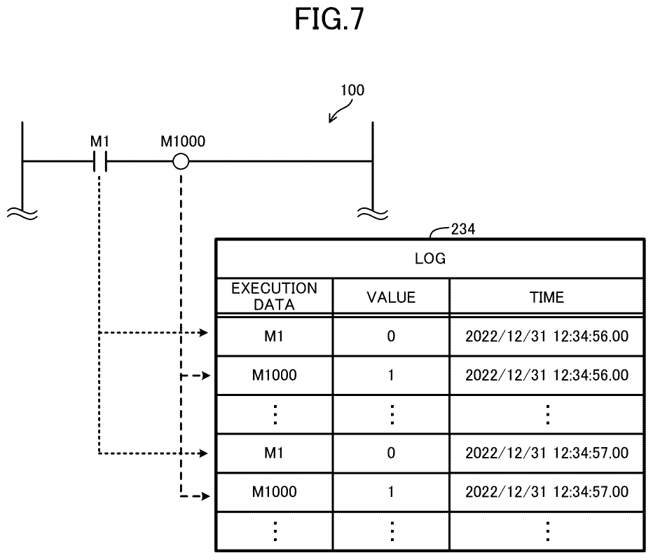

FIG. 7 illustrates a simple example of the execution program 233 and the log 234. As illustrated in FIG. 7, in a case where the execution program 233 is a ladder program, the log 234 is log data that indicates transition of values of the execution data by indicating values of devices or labels corresponding to the execution data used in the ladder program, in association with the times at which the devices or labels have the values.

With reference again to FIG. 3, the support terminal 10 includes a client unit 11, an analyzer 12, a display controller 13, a user interface (UI) 14, a receiver 15, and an outputter 16. The client unit 11 receives information from the server device 20. The analyzer 12 analyzes the information received by the client unit 11. The display controller 13 generates an image based on a result of analysis performed by the analyzer 12 to cause a display 141 of the UI 14 to display the image. The UI 14 presents the image to the user U1, and receives information input by the user U1. The receiver 15 receives the execution program 233 and the log 234 from the PLC 23 in accordance with a specific operation by the user U1. The outputter 16 outputs a file 161 indicating the image generated by the display controller 13.

The client unit 11 is mainly achieved by the processor 41 and the communicator 46 of the support terminal 10 operating in cooperation with each other. When communication that is in accordance with the OPC UA is established with the server units 211, 221, and 231, the client unit 11 periodically receives the information as illustrated in FIGS. 5-7 from the server units 211, 221, and 231. The cycle has a length of one second or one minute, for example. The information periodically received by the client unit 11 is sufficient as long as the information indicating the operating states of the server devices 20. The client unit 11 corresponds to an example of client means for receiving, from a server, information indicating an operating state of a programmable controller.

The analyzer 12 is mainly implemented by the processor 41 of the support terminal 10. The analyzer 12 analyzes the information received by the client unit 11, determines the operating state of each of the server devices 20, and sends a notification of a result of the determination to the display controller 13.

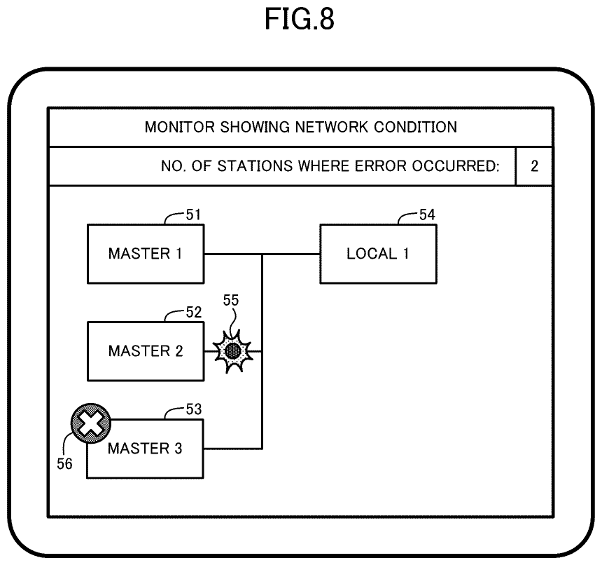

The display controller 13 is mainly implemented by the processor 41 of the support terminal 10. The display controller 13 generates an image indicating the operating states of the server devices 20 determined by the analyzer 12 using icons respectively corresponding to the server devices 20, and causes the display 141 of the UI 14 to display the image. FIG. 8 illustrates an example of an image displayed on the display 141. The image indicates a configuration of the network system 100 including a plurality of server devices 20. The image may also indicate a connection relationship of the server devices 20 by connecting the icons corresponding to the server devices 20 with lines. The icons correspond to an example of device icons corresponding to the server devices.

In FIG. 8, icons 51, 52, and 53 and an icon 54 are connected by lines. The icons 51, 52, and 53 represent “Master 1”, “Master 2”, and “Master 3” corresponding to the communication devices 21 and 22 and the PLC 23, respectively. The icon 54 represents “Local 1” corresponding to the support terminal 10. A mark 55 is displayed on the line connecting “Master 2” and “Local 1”, and a mark 56 is superimposed on the icon “Master 3”. The mark 55 indicates that an abnormality is occurred in communication with the communication device 22. The mark 56 indicates that an abnormality is occurred at the PLC 23. The mark 55 corresponds to an abnormality indicated by the status code. The mark 56 corresponds to an abnormality of the PLC 23 notified as a value of a node. The display controller 13 corresponds to an example of display controlling means for causing display means to display an image indicating the operating state using an icon corresponding to the programmable controller.

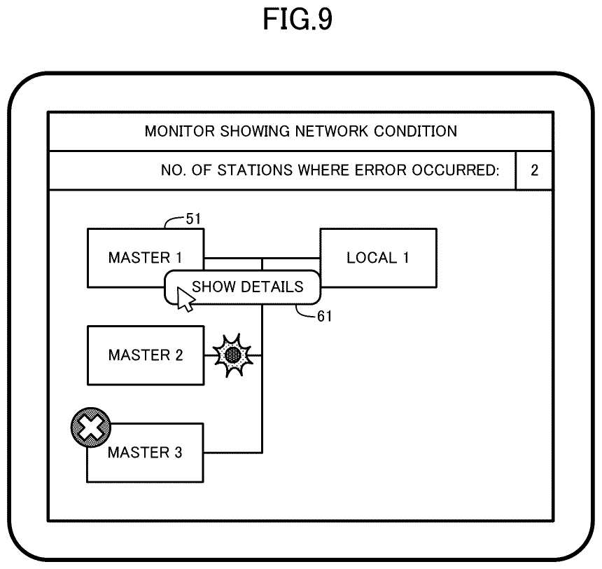

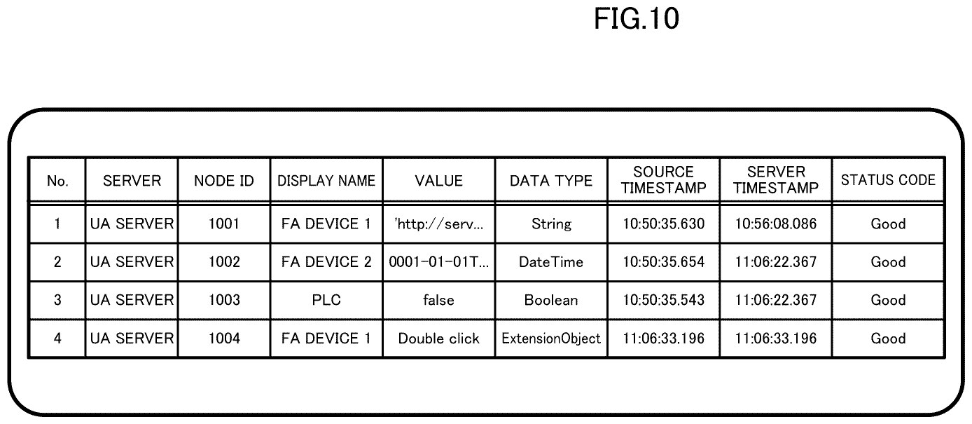

With reference again to FIG. 3, the UI 14 is mainly achieved by the inputter 44 and the outputter 45 of the support terminal 10 operating in cooperation with each other. The UI 14 includes the display 141 achieved by the outputter 45, and uses the image displayed on the display 141 to acquire information input by the user U1. For example, as illustrated in FIG. 9, the UI 14 accepts an operation to select an item “Show Details” from a submenu 61. The submenu 61 is displayed upon placing a cursor on the icon 51 and right-clicking the icon 51 with a mouse. The UI 14 accepted the operation sends a notification that the operation is accepted to the display controller 13, and the display controller 13 causes the display 141 to display a history of the information received from the server device 20 corresponding to the selected icon 51, as illustrated in FIG. 10.

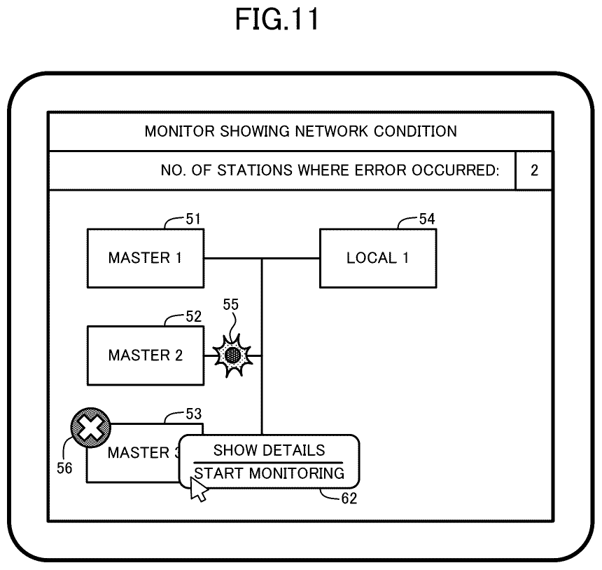

Furthermore, as illustrated in FIG. 11, the UI 14 accepts an operation to select an item “Start Monitoring” from a submenu 62. The submenu 62 is displayed upon placing a cursor on the icon 53 and right-clicking the icon 53 with the mouse. The UI 14 accepted the operation sends a notification that the operation is accepted to the receiver 15. The item “Start Monitoring” may be excluded from the submenu of the server device 20 in which no abnormality is occurred, and may be excluded from the submenus of the server devices 20 other than the PLC 23 that can provide the execution program 233 and the log 234. The UI 14 corresponds to an example of user interface means for accepting an operation on an icon.

With reference again to FIG. 3, the receiver 15 is mainly achieved by the processor 41 and the communicator 46 operating in cooperation with each other. Upon the UI 14 accepting the operation on “Start Monitoring”, the receiver 15 requests the server device 20 corresponding to the selected icon to send the execution program 233 and the log 234, and receives the execution program 233 and the log 234. In a case illustrated in FIG. 11, the receiver 15 receives the execution program 233 and the log 234 stored in the storage unit 232 of the PLC 23. The receiver 15 corresponds to an example of reception means. The reception means receives, when the operation is accepted by the user interface means, from the programmable controller, the execution program executed by the programmable controller and a log of the execution data used upon the execution of the execution program.

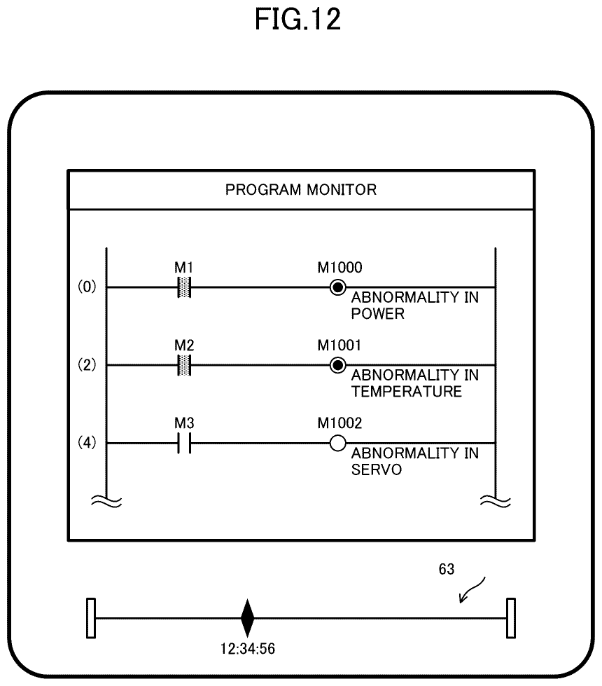

With reference again to FIG. 3, the receiver 15 provides the received execution program 233 and the received log 234 to the display controller 13, and the display controller 13 generates a monitoring image for observation of the execution program 233 and the log 234 by the user U1, and causes the display 141 to display the generated monitoring image. FIG. 12 illustrates an example of the monitoring image. In the example illustrated in FIG. 12, a time seek bar 63 and a monitoring image indicating a ladder diagram as the execution program 233 are displayed. In the ladder diagram, a value of the execution data corresponding to the time specified in the time seek bar 63 is indicated at a contact. Specifically, a contact “M1” is hatched to indicate that a device value at the contact is “1”, and a contact “M3” is not hatched but in solid white to indicate that the device value at the contact is zero. However, how the values of the execution data in the execution program 233 are presented are not limited to the example illustrated in FIG. 12, and may be changed as appropriate.

In the ladder diagram in FIG. 12, the execution data “M1000”, “M1001”, and “M1002” indicate whether a specific abnormality is occurred, as respectively labeled “Abnormality in Power”, “Abnormality in Temperature”, and “Abnormality in Servo”. The user U1 may observe the transition of the values of the execution data to verify the operation history of the PLC 23 and identify the cause of the abnormality in the control system. The display controller 13 corresponds to an example of display controlling means for causing display means to display the execution program and the log received by the reception means.

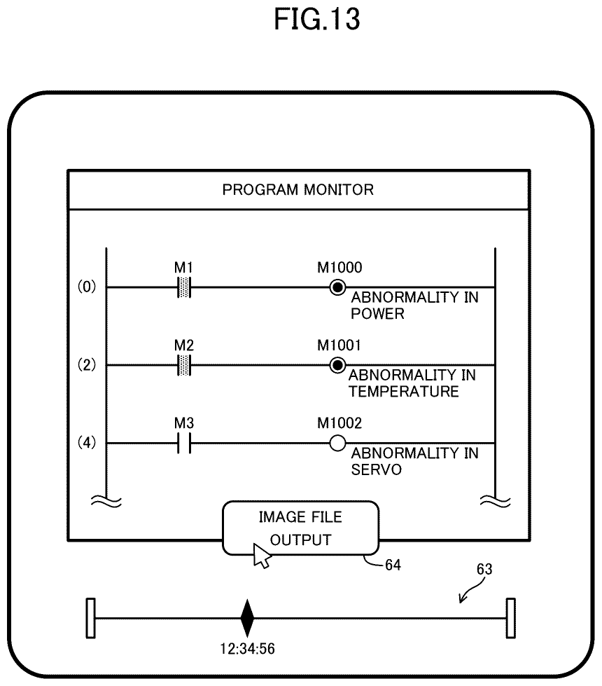

A submenu 64 is displayed as illustrated in FIG. 13 upon placing the cursor on the monitoring image illustrated in FIG. 12 and right-clicking the monitoring image with the mouse. When an operation is performed to select an item “Image File Output” from the submenu 64, the UI 14 sends a notification that the operation is accepted to the outputter 16. Furthermore, the submenu 64 is similarly displayed in the image illustrated in FIG. 8. When an operation is performed to select the item “Image File Output” from the submenu 64, the UI 14 sends a notification that the operation is accepted to the outputter 16.

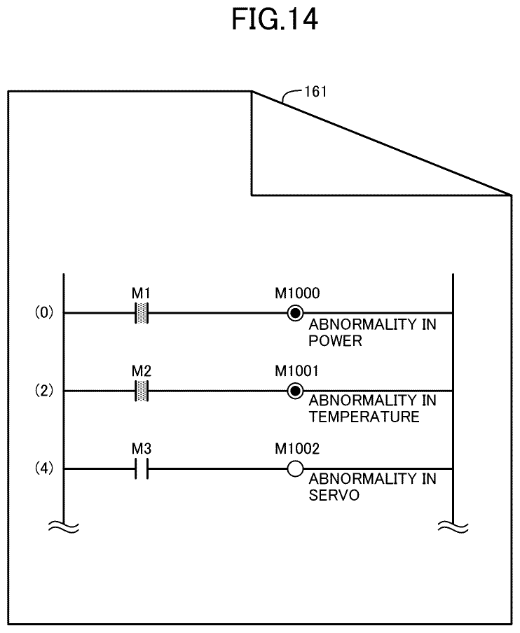

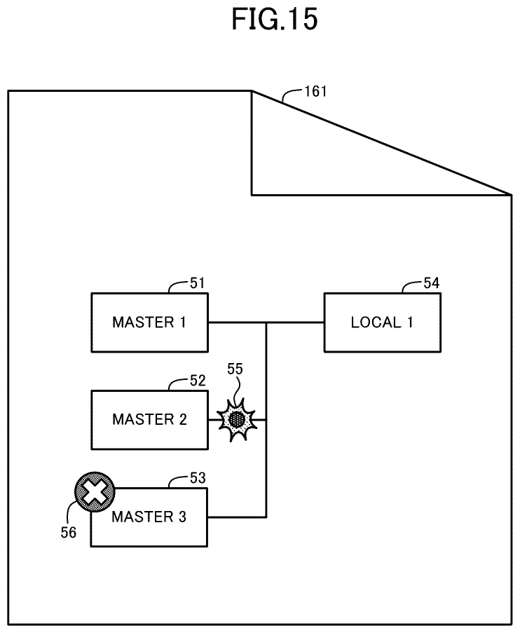

With reference again to FIG. 3, the outputter 16 is mainly achieved by the processor 41, the auxiliary storage 43, and the communicator 46 of the support terminal 10 operating in cooperation with one another. Upon receiving the notification about the monitoring image from the UI 14, the outputter 16 outputs the file 161 indicating the monitoring image as illustrated in FIG. 14. Similarly, upon receiving the notification about the image in FIG. 8, the outputter 16 outputs the file 161 indicating a configuration of the network system 100 as illustrated in FIG. 15. A destination of the file 161 may be the auxiliary storage 43 of the support terminal 10, a storage device provided outside the support terminal 10, or a recording medium such as a memory card inserted into the support terminal 10. The file 161 is used, for example, by the user U1 who is in charge of the verification work to communicate the verification results to others. The outputter 16 corresponds to an example of output means for outputting a file indicating an image.

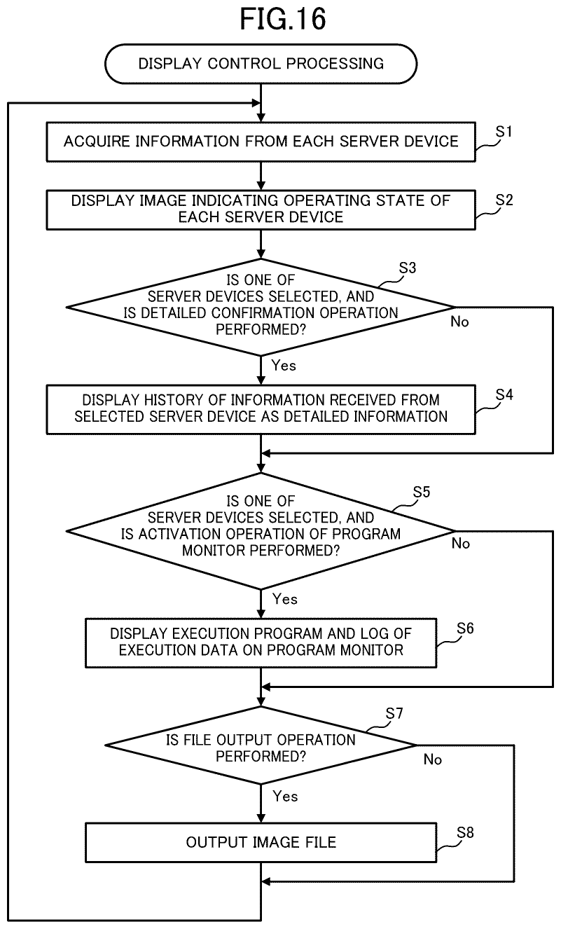

The display control processing executed by the support terminal 10 is described below with reference to FIG. 16. The display control processing corresponds to an example of a display control method to be executed by the support terminal 10 as a client device.

In the display control processing, the client unit 11 acquires information from each server device 20 (step S1), and the display controller 13 displays an image corresponding to a network configuration indicating an operating state of each server device 20 as illustrated in FIG. 8 (step S2).

Next, the UI 14 of the support terminal 10 selects one of the server devices 20 in the network configuration, and determines whether a detailed confirmation operation is performed (step S3). Here, the detailed confirmation operation corresponds to selecting the item “Show Details” illustrated in FIG. 9. In a case where a determination is made that the detailed confirmation operation is not performed (No in step S3), the processing performed by the support terminal 10 advances to step S5.

In contrast, in a case where a determination is made that the detailed confirmation operation is performed (Yes in step S3), a history of the information received from the selected server device 20 is displayed as detailed information (Step S4). Specifically, the display 141 displays a list of sets of information previously received in a table format, as illustrated in FIG. 10.

Next, the UI 14 of the support terminal 10 selects one of the server devices 20 in the network configuration, and determines whether an activation operation to activate a program monitor is performed (step S5). Here, the activation operation of the program monitor corresponds to selecting the item “Start Monitoring” illustrated in FIG. 11. In a case where a determination is made that the activation operation of the program monitor is not performed (No in step S5), the processing performed by the support terminal 10 advances to step S7.

In contrast, in a case where a determination is made that the activation operation of the program monitor is performed (Yes in step S5), the display 141 displays the execution program 233 and the log 234 of the execution data on the program monitor (Step S6). Specifically, the display 141 displays an image in which the log 234 is applied on the execution program 233, as illustrated in FIG. 12.

Next, the UI 14 of the support terminal 10 determines whether a file output operation of outputting a file is performed in the network configuration or in the program monitor displayed in step S6 (step S7). Here, the file output operation corresponds to selecting the item “Image File Output” illustrated in FIG. 13. In a case where a determination is made that the file output operation is not performed (No in step S7), the support terminal 10 then repeats step S1 and the subsequent steps.

In contrast, in a case where a determination is made that the file output operation is performed (Yes in step S7), the outputter 16 outputs the file 161 indicating the image on which the file output operation is performed (step S8). The support terminal 10 then repeats step S1 and the subsequent steps.

As described above, in the support terminal 10 according to the present embodiment, the UI 14 accepts the operation on the icon, the receiver 15 receives the execution program 233 and the log 234 of the execution data from the PLC 23, and the display controller 13 causes the display 141 to display the execution program 233 and the log 234. As such, the user U1 is not necessarily experienced in handling databases, and the user U1 can visually check the execution program 233 and the log 234 of the execution data. This reduces the workload for verifying the operation history of the PLC 23.

Additionally, tools for an operator to confirm, on the client side of OPC UA, the received information in a table format as illustrated in FIG. 10 or in a text format are known. However, such tools have poor browsability, making it time-consuming to confirm the contents. In contrast, in the support terminal 10 according to the present embodiment, the operating states of the server devices 20 in the configuration of the network system 100 are indicated using icons, and operations using a pointing device by the user U1 are accepted. By providing such a GUI to the user U1, the workload on the user U1 can be significantly reduced.

Furthermore, the information received by the client unit 11 from the server units 211, 221, and 231 indicates the presence or absence of abnormalities in the server devices 20 as the operating states of the server devices 20. As illustrated in FIG. 8, the display controller 13 causes the display 141 to display icons for the server devices 20 along with the marks 55 and 56 indicating the occurrence of abnormalities. This allows the user U1 to easily recognize the location of abnormalities in the network system 100. Note that the method of expressing the presence or absence of abnormalities in the server devices 20 is not limited to adding marks to the icons. For example, the icons of the server devices 20 with abnormalities and the icons of the server devices 20 without abnormalities may be different. It is sufficient to display the icons in a manner corresponding to the presence or absence of abnormalities.

Additionally, an example in which the user U1 verifies the operation history of the PLC 23 based on the log 234 of the execution data stored in the storage unit 232 of the PLC 23 is described. The log 234 may include log data that is continuously recorded regardless of the presence or absence of abnormalities, and log data recorded before and after the detection of abnormalities in the PLC 23.

Although one or more embodiments of the present disclosure have been described above, the present disclosure is not limited to the above embodiments.

For example, in the example described above, the communication between the server units 211, 221, and 231 and the client unit 11 is performed in accordance with the OPC UA, but the communication may be performed using other communication protocols. However, it is desirable use communication protocols having features equivalent to or similar to the OPC UA. Examples of the features include being capable of having security functions including encryption, transmitting information that is in accordance with a predetermined information model to facilitate the interpretation of information between devices with different OSs, models, and manufacturers, and installing a server function or a client function independent of the OSs, models, or manufacturers of the communicating devices.

Additionally, when creating a program monitor as illustrated in FIG. 12, the display controller 13 may generate an image in which the execution data at the time associated with the occurrence of an abnormality in the information received by the client unit 11 is applied to the execution program 233 to display the image on the display 141 first. This allows the user U1 to easily verify the transition of execution data before and after the occurrence of the abnormality.

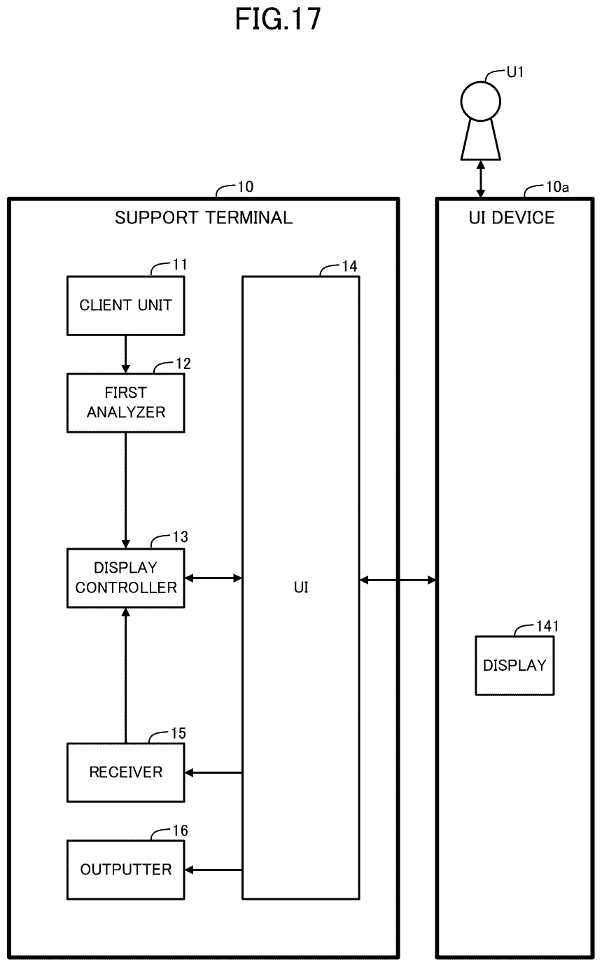

Although the support terminal 10 is described as having the display 141 in the example above, the example is not limited to this. For example, as illustrated in FIG. 17, the user U1 may operate a UI device 10a based on the information provided from the UI device 10a, and the UI unit 14 may function as an interface with the user U1 in the support terminal 10 by communicating with the UI device 10a. The UI device 10a is different from the support terminal 10. In the example of FIG. 17, the UI unit 14 is implemented by the communicator 46 of the support terminal 10, and the display controller 13 causes the display 141 of the UI device 10a to display an image.

Additionally, although the operating state of the server device 20 is described as mainly focusing on a state indicating the presence or absence of an abnormality in the example above, the example is not limited to this. The operating state of the server device 20 may indicate an operating mode of the server device 20 among a plurality of predetermined modes.

The functions of the support terminal 10 and the PLC 23 according to the embodiments above can be implemented by a dedicated hardware device or by a general-purpose computer system.

For example, the program P1 may be stored in a non-transitory computer-readable recording medium, such as a flexible disc, a compact disc read-only memory (CD-ROM), a digital versatile disc (DVD), or a magneto-optical (MO) disk, for distribution. The program P1 can be installed in a computer to provide a device that performs the above processing.

The program P1 may be stored in a disk device included in a server device on a communication network such as the Internet, and may be, for example, superimposed on a carrier wave to be downloaded to a computer.

The processing described above may also be performed by the program P1 activated and executed while being transferred through a communication network such as the Internet.

The processing described above may also be performed by entirely or partially executing the program P1 on a server device while a computer is transmitting and receiving information about the processing through a communication network.

In the system with the above functions implementable partially by the operating system (OS) or through cooperation between the OS and applications, portions executable by applications other than the OS may be stored in a non-transitory recording medium that may be distributed or may be downloaded to the computer.

Means for implementing the functions of the support terminal 10 and the PLC 23 is not limited to software. The functions may be partially or entirely implemented by dedicated hardware or a dedicated circuit.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is appropriate for verification of an operation history of the PLC at FA sites.

### REFERENCE SIGNS LIST

100 Network system
10 Support terminal
10a User interface (UI) device
11 Client unit
12 Analyzer
13 Display controller
14 UI
141 Display
15 Receiver
16 Outputter
161 File
20 Server device
21, 22 Communication device
211, 221, 231 Server unit
23 Programmable logic controller (PLC)
232 Storage unit
233 Execution program
234 Log
30 Network
40 Factory automation (FA) device
41 Processor
42 Main storage
43 Auxiliary storage
44 Inputter
45 Outputter
46 Communicator
47 Internal bus
51-54 Icon
55,56 Mark
61, 62, 64 Submenu
63 Time seek bar
P1 Program
U1 User

1. A non-transitory computer-readable recording medium storing a display program, the display program causing a computer connectable through a network to a programmable controller having a function of a server encrypting and distributing information that is in accordance with a predetermined information model, to execute processing comprising:
receiving from the server the information indicating occurrence of an abnormality in the programmable controller;
causing a display to display an image including an icon corresponding to the occurrence of the abnormality in the programmable controller;
accepting an operation on the icon;
receiving from the programmable controller, when the operation is accepted, an execution program executed by the programmable controller and a log of execution data used upon execution of the execution program; and
causing the display to display the execution program and the log that are received, wherein
the receiving of the information includes receiving the information including a value of a node in the information model and a status code associated with the value of the node, and
the causing the display to display the image includes causing the display to display the occurrence of the abnormality notified as the value of the node and the occurrence of the abnormality indicated by the status code in a different manner.

2. (canceled)

3. The non-transitory computer-readable recording medium according to claim 1, wherein
the receiving of the information includes receiving the information indicating the occurrence of the abnormality in association with a time,
the log received indicates transition of the execution data, and
the causing the display to display the execution program and the log includes causing the display to display, together with the execution program, the execution data at the time associated with the occurrence of the abnormality.

4. The non-transitory computer-readable recording medium according to claim 1, wherein
the computer is connected through the network to a plurality of server devices having a function of the server, the plurality of server devices including the programmable controller, and
the image displayed indicates a configuration of the network using device icons corresponding to the plurality of respective server devices.

5. The non-transitory computer-readable recording medium according to claim 1, the display program further causing the computer to execute processing comprising:
outputting a file indicating the image.

6. A client device to be connected through a network to a programmable controller having a function of a server encrypting and distributing information that is in accordance with a predetermined information model, the client device comprising:
a first receiver to receive from the server the information indicating occurrence of an abnormality in the programmable controller;
processing circuitry to
cause a display to display an image including an icon corresponding to the occurrence of the abnormality in the programmable controller and
accept an operation on the icon; and
a second receiver to receive from the programmable controller, when the operation is accepted, an execution program executed by the programmable controller and a log of execution data used upon execution of the execution program, wherein
the first receiver receives the information including a value of a node in the information model and a status code associated with the value of the node, and
the processing circuitry
causes the display to display the occurrence of the abnormality notified as the value of the node and the occurrence of the abnormality indicated by the status code in a different manner, and
causes the display to display the execution program and the log that are received.

7. A network system, comprising:
the client device according to claim 6; and
the programmable controller to be connected through the network to the client device.

8. A display control method to be performed by a client device connectable through a network to a programmable controller having a function of a server encrypting and distributing information that is in accordance with a predetermined information model, the display control method comprising:
receiving, by a first receiver, from the server the information indicating occurrence of an abnormality in the programmable controller, the information including a value of a node in the information model and a status code associated with the value of the node;
causing, by a display controller, a display to display an image including an icon corresponding to the occurrence of the abnormality in the programmable controller;
accepting, by a user interface, an operation on the icon; and
receiving, by a second receiver, from the programmable controller, when the operation is accepted by the user interface, an execution program executed by the programmable controller and a log of execution data used upon execution of the execution program, wherein
the display controller causes the display to display the execution program and the log that are received by the second receiver,
the display controller causes the display to display the occurrence of the abnormality notified as the value of the node and the occurrence of the abnormality indicated by the status code in a different manner.

9. The non-transitory computer-readable recording medium according to claim 3, wherein
the causing the display to display the execution program and the log includes
causing the display to initially display, together with a time seek bar, the execution data at the time associated with the occurrence of the abnormality, and
causing the display to display the execution data at the time designated with the time seek bar.
